(19) United States
(12) Patent Application Publication
(10) Pub. No.: US 2023/0405913 A1
(43) Pub. Date: Dec. 21, 2023

(54) PROCESS FOR MOULDING A COMPOSITE PRODUCT FOR COATINGS

(71) Applicant: PERSICO S.P.A., NEMBRO (IT)

(72) Inventors: Sergio Battista GASTALDI, Nembro (IT); Andrea FUMAGALLI, Nembro (IT)

(21) Appl. No.: 18/252,236

(22) PCT Filed: Oct. 18, 2021
(86) PCT No.: PCT/IT2021/050337

§ 371 Date: May 9, 2023

(30) Foreign Application Priority Data
Nov. 13, 2020 (IT) 102020000027227

(51) Int. Cl. B29C 51/14; B32B 5/18; B32B 37/06; B32B 37/10; B32B 37/08; B32B 9/02; B32B 9/04; B32B 5/02; B32B 5/24; B32B 27/30; B32B 27/40; B32B 27/12; B32B 7/02; B32B 38/18; B32B 7/12

(52) U.S. Cl. CPC B29C 51/14; B32B 5/18; B32B 37/06; B32B 37/10; B32B 37/08; B32B 9/025; B32B 9/046; B32B 5/022; B32B 5/245; B32B 27/304; B32B 27/40; B32B 27/12; B32B 7/02; B32B 38/1866; B32B 5/026; B32B 5/024; B32B 7/12; B32B 2266/025; B32B 2305/022; B32B 2317/08; B32B 2323/00; B32B 2262/0276; B32B 2262/0261; B32B 2367/00; B32B 2377/00; B32B 2260/021; B32B 2260/046; B32B 2305/076; B32B 2327/06; B32B 2375/00; B32B 2262/16; B32B 2307/7376; B32B 2307/72; B32B 2266/08; B32B 2307/54; B32B 2307/734; B32B 2309/02; B32B 2305/186; B32B 2305/188; B32B 2605/003; B32B 2305/20; B29K 2105/256

(57) ABSTRACT

Process for moulding a composite product (9) for coatings, comprising providing an aesthetic layer (1) comprising an aesthetic material chosen from: natural leather, a first composite material comprising a textile layer and a coating layer comprising polyurethane or polyvinyl chloride or thermoplastics olefins and a second composite material comprising a non-woven fabric comprising polyester or polyamide fibres immersed in a polyurethane matrix, with the polyurethane in weight percentage greater than or equal to 15% and less than or equal to 60% and the polyester or the polyamide in weight percentage greater than or equal to 40% and less than or equal to 85%, providing a support layer (2) comprising a solid polyolefin thermoplastic foam, providing a semi-finished product (3) comprising the aesthetic layer (1) and the support layer (2) coupled together, heating the semi-finished product (3) to bring the support layer (2) to a plastic state, forming the semi-finished product (3) by pressing against each other a first (11) and a second half-mould (12) of a mould (10) with the semi-finished product (3) interposed between the conformation surfaces (13) of the two half-moulds, and with the support layer (2) in the plastic state, cooling the semi-finished product (3) to bring the support layer (2) to a solid state and to realize the composite product (9).

### TECHNICAL FIELD OF THE INVENTION

The present invention relates to a process for moulding a composite product for coatings, for example for the interior trim parts of motor vehicles (e.g. dashboards, roof pavilions, door panels, etc.), boats or aircrafts.

### STATE OF THE ART

For the production of composite products for interior trim parts of motor vehicles there are used some types of materials (typically forming the aesthetic layer of these trim parts), such as for example natural leather or artificial leather, as for example materials marketed under the name Alcantara™ or Ultrasuede™ or Feel Tek™, which are typically considered in the industry as hardly thermoformable, or not thermoformable, through a moulding process. In such cases, and typically in the presence of complex three-dimensional shapes of the final product, a preliminary phase of cutting and sewing (e.g. manually or by means of special machinery) patches of this material is provided to make a semi-finished product constituted by the patches sewn together and having appropriate extension (and already provided with a three-dimensional shape that approaches the final shape of the composite product), and subsequently a moulding phase to definitively form the semi-finished product, during which the semi-finished product is made to adhere to a rigid support already having the final shape of the product (possibly with the interposition of an adhesive layer).

### SUMMARY OF THE INVENTION

The Applicant has observed that the known processes for production of composite products for interior trim parts in the automotive field with materials that are hardly thermoformable, or not thermoformable, have some drawbacks and/or can be improved under some aspects.

According to the Applicant, the materials that are hardly (or not) thermoformable, when subjected to stress deformation (at room temperature or at the typical moulding temperatures, e.g. about 100° C.) are not subject to plastic deformation (i.e. such that, once the strain is released, the deformation is maintained). In other words, these materials, once left free from stresses, tend to change their shape and/or to return to their original shape. Therefore, the aforementioned materials hardly (or not) thermoformable, in particular when in single piece with a large surface extension and/or in case of complex three-dimensional shapes, are not able, after moulding, to assume and/or to permanently and precisely maintain the shape of the final product. This generates surface defects, such as failure in reproducing the surface geometries, in particular at regions with small radius of curvature, and/or subsequent detachment of the aesthetic material from the support (hence the reference to such materials as “hardly thermoformable or not thermoformable”).

The aforementioned preliminary phase of cutting and sewing the patches allows to accurately follow the superficial shape of the product with the aesthetic material that is hardly (or not) thermoformable, providing sewing lines at the regions with more complex geometry, so that the surface extension of each patch remains limited and/or that each patch covers surface regions with simpler geometry (e.g. substantially planar and/or with large radii of curvature).

However, this preliminary cutting and sewing phase involves an increase in the times and/or costs of the production process, since, for example, it is necessary to accurately make the single patches, provide the machinery or the specialized workers for the sewing phase, etc.

The Applicant has therefore faced the problem of producing by moulding a composite product for coatings comprising materials that are hardly thermoformable, or not thermoformable, in simple, rapid, economical way, without at the same time jeopardizing the aesthetic qualities and the structural toughness qualities of the finished composite product.

The Applicant has surprisingly realized that the aforesaid problem is solved by moulding, in a single moulding process, a semi-finished product comprising an aesthetic layer of hardly (or not) thermoformable material and a support layer of polyolefin foam.

According to an aspect the invention relates to a process for moulding a composite product for coatings.

The process comprises:
providing an aesthetic layer comprising an aesthetic material selected from the following group of materials: natural leather, a first composite material comprising a textile layer and a covering layer comprising polyurethane (PU) or polyvinyl chloride (PVC) or thermoplastic olefins (TPO) and a second composite material comprising (at least) a non-woven fabric comprising polyester or polyamide fibres immersed in a polyurethane matrix, wherein said polyurethane is in weight percentage greater than or equal to 15% and less than or equal to 60% and said polyester or said polyamide is in weight percentage greater than or equal to 40% and less than or equal to 85%;
providing a support layer comprising a polyolefin thermoplastic solid foam;
providing a semi-finished product comprising said aesthetic layer and said support layer coupled together;
providing a mould comprising a first and a second half-mould each having a respective conformation surface;
heating said semi-finished product to bring said support layer to a plastic state;
forming said semi-finished product by pressing said first and second half-mould against each other with said semi-finished product interposed between said conformation surfaces, and with said support layer in said plastic state;
subsequently to said forming, cooling said semi-finished product to bring said support layer to a solid state and to realize said composite product.

By aesthetic layer it is meant the layer that remains visible in the finished product to confer the desired aesthetic and/or tactile properties.

The Applicant has experimented that the process according to the present invention is particularly adapted to the forming of the aforementioned semi-finished products comprising an aesthetic layer in the aforementioned types of materials (i.e. natural leather, first composite material, second composite material, which are considered hardly (or not) thermoformable materials in the moulding industry), since, thanks to the coupling with the support layer of polyolefin thermoplastic foam that is thermoformed (namely heated and formed) together with the aesthetic layer, they are able to assume, and subsequently to permanently maintain, with accuracy the desired final superficial shape, even in presence of complex three-dimensional shapes and/or having small radii of curvature, without necessarily having to resort to any preliminary cutting and sewing phase, or at least reducing the burden of such cutting and sewing phases. In this way, the costs and the times associated with the moulding process are reduced. The present invention in one or more of the above aspects may have one or more of the following preferred features.

Preferably said aesthetic layer is entirely made of said aesthetic material. In this way the process is simple.

Preferably said composite product comprises said support layer in the solid state as sole layer having self-supporting function. In this way the product is simple, since no substrates intended to give structural rigidity to the product are needed.

Preferably said aesthetic layer is in single piece (that is, it does not comprise joints, such as for example seams, welds, gluing, and/or solutions of continuity in general along a surface extension thereof such as to achieve said surface extension).

Typically, the covering layer of the first composite material can be made by spreading and/or impregnating the textile layer with the polyurethane or the polyvinyl chloride. Optionally, the first composite material can further comprise a functional layer, typically of non-woven fabric, interposed between the textile layer and the covering layer, or arranged at the opposite side of the textile layer with respect to the covering layer. In this way the structural properties of the first composite material are improved.

Typically said first and second composite materials are artificial leather (i.e. they have aesthetic and/or tactile and/or mechanical properties that recall the natural leather). In particular, the first composite material recalls natural fur-free leather. In particular, the second composite material recalls natural suede leather (e.g. cowhide).

Preferably said textile layer of the first composite material is woven fabric or knitted fabric or non-woven fabric. In this way the textile layer is light and at the same time sturdy.

Preferably said textile layer of the first composite material is made of synthetic textile fibres (e.g. polyester, aramid) or of natural textile fibres (e.g. cotton, wool).

Preferably said first composite material is Feel Tek™ (marketed by Mario Levi S.p.a.).

Preferably in said second composite material a sum of the weight percentages of said polyurethane and of said polyester or said polyamide is greater than or equal to 95%, more preferably it is equal to 100%, of a whole mass of said second composite material.

Preferably said fibres of said second composite material are entirely of polyester, more preferably they are coagulated polyester fibres.

Preferably said fibres of said second composite material have diameter less than or equal to 50 μm, more preferably less than or equal to 20 μm, even more preferably less than or equal to 10 μm.

In a particularly preferred embodiment said second composite material is selected from the following: Alcantara™, Ultrasuede™. These materials confer the desired aesthetic properties.

Preferably said aesthetic layer, before said heating said semi-finished product, has thickness greater than or equal to 0.5 mm, and less than or equal to 1.3 mm.

Preferably said aesthetic layer, before said heating said semi-finished product, has density per unit surface greater than or equal to 180 g/m², more preferably greater than or equal to 190 g/m², and less than or equal to 280 g/m², more preferably less than or equal to 270 g/m².

Preferably said foam is made of polypropylene (PP) or polyethylene (PE).

In one preferred embodiment said foam is entirely made of polypropylene.

Preferably said foam is crosslinked with physical agents (e.g. heat, ionizing radiation, etc.).

Preferably said foam has closed cells.

Preferably said foam is, more preferably entirely, Trocellen™ vertical (marketed by Trocellen GmbH).

Preferably said foam, before said heating said semi-finished product, has density greater than or equal to 40 kg/m³, more preferably greater than or equal to 55 kg/m³, and/or less than or equal to 90 kg/m³, more preferably less than or equal to 75 kg/m³. In this way the density is such as to allow the finished product to maintain its shape after the forming phase.

Preferably said foam, before said heating said semi-finished product, has longitudinal tensile strength measured according to ISO 1798 standard greater than or equal to 0.5 MPa, more preferably greater than or equal to 1 MPa, and less than or equal to 2 MPa, more preferably less than or equal to 1.5 MPa.

Preferably said foam, before said heating said semi-finished product, has transversal tensile strength measured according to ISO 1798 standard greater than or equal to 0.3 MPa, more preferably greater than or equal to 0.5 MPa, and less than or equal to 1 MPa, more preferably less than or equal to 0.8 MPa.

Preferably said foam, before said heating said semi-finished product, has longitudinal strain at break measured according to ISO 1798 standard greater than or equal to 400%, more preferably greater than or equal to 450%, and less than or equal to 600%, more preferably less than or equal to 550%.

Preferably said foam, before said heating said semi-finished product, has transversal strain at break measured according to ISO 1798 standard greater than or equal to 300%, more preferably greater than or equal to 350%, and less than or equal to 450%, more preferably less than or equal to 400%.

Preferably said foam, before said heating said semi-finished product, has compression stress at 25% strain measured according to ISO 3386/1 standard greater than or equal to 30 kPa, more preferably greater than or equal to 35 kPa, and less than or equal to 50 kPa, more preferably less than or equal to 45 kPa.

Preferably said foam, before said heating said semi-finished product, has compression stress at 50% strain measured according to ISO 3386/1 standard greater than or equal to 70 kPa, more preferably greater than or equal to 75 kPa, and less than or equal to kPa, more preferably less than or equal to 85 kPa.

Preferably said foam, before said heating said semi-finished product, has dimensional stability measured according to ISO 2796 standard greater than or equal to 120° C., more preferably greater than or equal to 125° C., and less than or equal to 140° C., more preferably less than or equal to 135° C.

The Applicant has experimentally verified that the aforementioned materials for the thermoplastic foam and/or the aforementioned ranges of values of the physical properties of the thermoplastic foam make the support layer particularly suitable for being thermoformed together with the aesthetic layer to contribute to the thermoforming of the latter.

Preferably, before said forming said semi-finished product, more preferably before said heating said semi-finished product, a thickness of said support layer is greater than or equal to 1.5 mm, and less than or equal to 2.5 mm.

Preferably said semi-finished product, before said forming said semi-finished product, has substantially planar shape.

Preferably it is provided arranging said semi-finished product with said aesthetic layer and said support layer firmly adhered to each other.

Preferably said providing said semi-finished product comprises firmly adhering said aesthetic layer and said support layer to each other by means of a flame adhesion process comprising:
superficially heating said support layer, to bring (at least) one face of said support layer to a plastic state,
subsequently, placing said aesthetic layer on said face in said plastic state,
cooling said face to solidify said face and to obtain adhesion.

In this way the use of adhesives is avoided.

In one embodiment said providing said semi-finished product comprises firmly adhering said aesthetic layer and said support layer to each other by means of an adhesive layer, for example a polyolefin or polyurethane or neoprene adhesive. In this way the semi-finished product is made in a simple way.

Preferably said heating said semi-finished product is performed outside said mould. In this way, the heating is accurately controlled.

Preferably said process, before said heating said semi-finished product, comprises fixing said semi-finished product to a support frame. Typically, the support frame keeps the semi-finished product under tension. Optionally, for example in case of moulding of composite products having surface geometries with wide three-dimensional development (e.g. with accentuated ridges and/or valleys, which require abundance of material), the semi-finished product can be fixed to the support frame to create a more or less pronounced loop (in order to provide such abundance of material for the moulding).

Preferably said heating said semi-finished product is performed with said semi-finished product fixed to said support frame. In this way the heating results simple.

Preferably said heating said semi-finished product comprises bringing said support layer and said aesthetic layer to respective mutually different temperatures. The Applicant has observed that the differential heating of the semi-finished product (i.e. wherein the temperatures of the two layers are different from each other) facilitates the forming of the semi-finished product limiting the risk of damaging with the heat the aesthetic layer (typically more sensitive than the support layer).

Preferably said heating said semi-finished product comprises providing heat directly to said support layer, more preferably by irradiation. In this way the heating of the semi-finished product aimed at bringing the support layer to the plastic state is simplified.

Preferably said heating said semi-finished product comprises bringing said support layer to a temperature greater than or equal to 180° C., more preferably greater than or equal to 200° C., and less than or equal to 240° C., more preferably less than or equal to 220° C. These temperatures are sufficient to bring the support layer to the plastic state. Preferably said heating said semi-finished product comprises providing heat directly also to said aesthetic layer, more preferably by irradiation, even more preferably to bring said aesthetic layer to a temperature greater than or equal to 70° C., more preferably greater than or equal to 80° C., and less than or equal to 110° C., more preferably less than or equal to 100° C. Heating the aesthetic layer within the described temperature range allows facilitating the forming of the aesthetic layer without damaging it. Furthermore, by limiting the temperature difference between the aesthetic layer and the support layer, it is limited the overall thermal stress to which the aesthetic layer and/or the whole semi-finished product is subjected.

Preferably said forming said semi-finished product is performed with said semi-finished product fixed to said support frame. In this way, the forming and/or the subsequent removal of the finished product from the mould is facilitated.

Preferably, during said forming, each of said aesthetic layer and support layer is arranged directly in contact with a respective conformation surface. In this way the process is simple and no further layers are needed (e.g. substrates providing structural rigidity) to make the finished product.

Preferably said cooling said semi-finished product is performed by means of at least one of (more preferably by means of both) said first and second half-mould placed at temperature lower than a temperature of said aesthetic layer as a consequence of said heating said semi-finished product. For example, the two half-moulds placed at room temperature (e.g. about 20-25° C.), given their high thermal inertia, are sufficient to cool the semi-finished product. Optionally, a thermal conditioning (e.g. cooling) system of one or both the half-moulds can be provided.

### BRIEF DESCRIPTION OF THE DRAWINGS

FIGS. 1-3 show in a purely schematic way some exemplary steps of a process for moulding according to the present invention;

FIG. 4 shows in a purely schematic way a composite product for coatings obtained by means of the process of FIGS. 1-3.

### DETAILED DESCRIPTION OF SOME EMBODIMENTS OF THE INVENTION

The features and the advantages of the present invention will be further clarified by the following detailed description of some embodiments, presented by way of non-limiting example of the present invention, with reference to the attached figures (not to scale with regard to the shown elements).

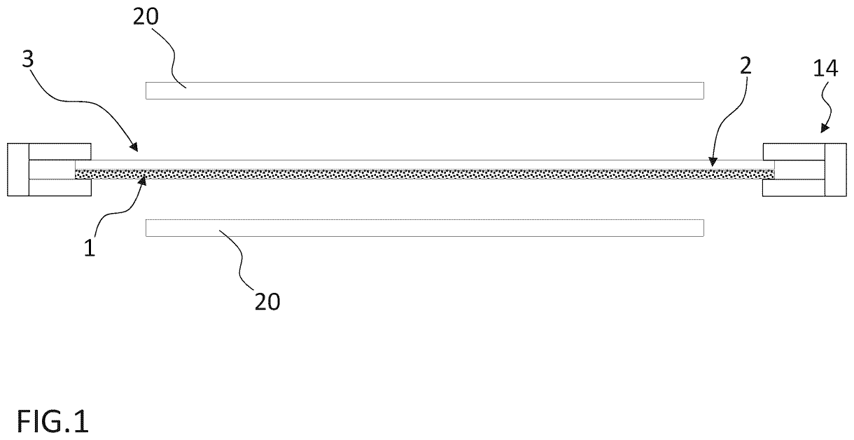

An exemplary process for moulding a composite product 9 (FIG. 4) according to the present invention is described in the following, wherein FIGS. 1-3 show in a purely schematic way some sections of elements used in the process.

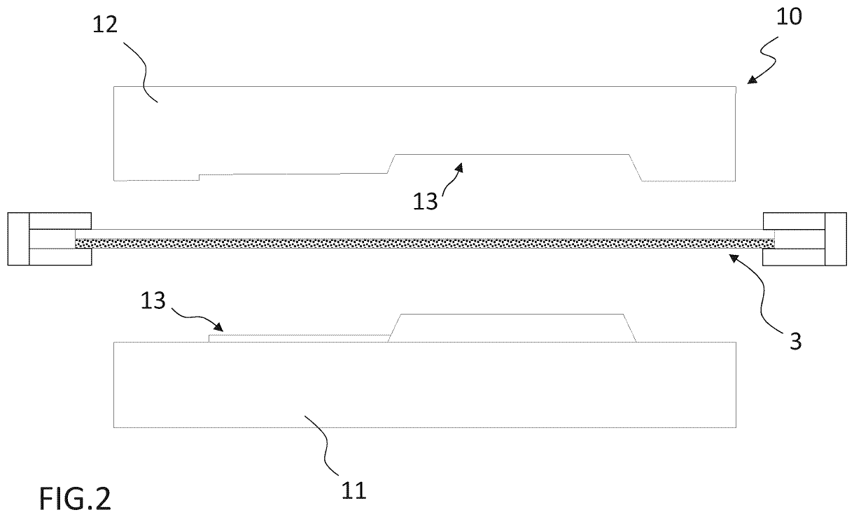

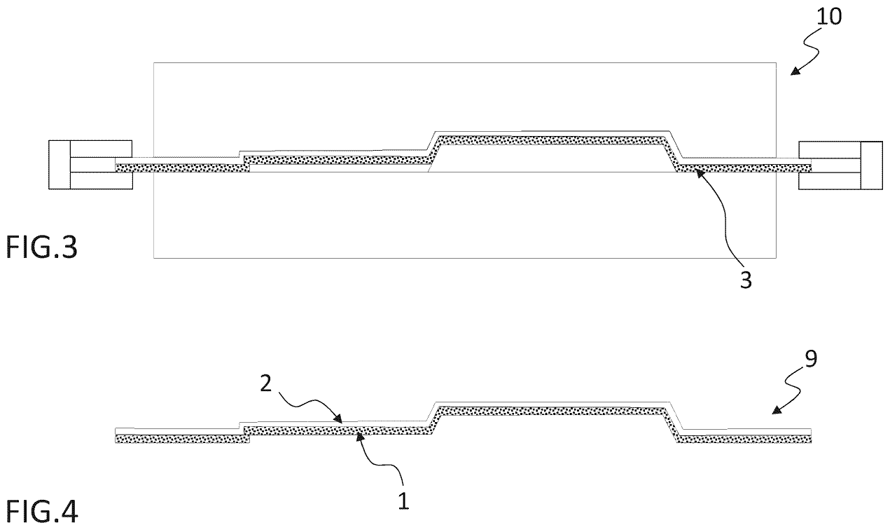

The process for moulding exemplarily comprises providing a mould 10 comprising a first half-mould 11 and a second half-mould 12 (schematically shown in FIGS. 2 and 3), each half-mould having a respective conformation surface 13.

Exemplarily it is provided providing an aesthetic layer 1 (only schematically shown) in single piece entirely made of an aesthetic material selected from the following group of materials: natural leather, a first composite material comprising a textile layer and a covering layer comprising polyurethane or polyvinyl chloride or thermoplastic olefins and a second composite material comprising at least a non-woven fabric comprising polyester or polyamide fibres immersed in a polyurethane matrix, wherein the polyurethane is in weight percentage greater than or equal to 15% and less than or equal to 60% and the polyester or the polyamide is in weight percentage greater than or equal to 40% and less than or equal to 85%.

Typically both the first and the second composite materials are artificial leather.

In particular, the first composite material recalls natural fur-free leather. For example, the first composite material can be Feel Tek™, in which the textile layer can be made of woven fabric and comprise natural fibres (e.g. cotton) and the covering layer is made of polyurethane.

In particular, the second composite material recalls natural suede leather. For example, the second composite material can be Alcantara™, in which the fibres are entirely coagulated polyester fibres with diameter less than 50 μm, wherein the polyurethane is in weight percentage equal to 32% and the polyester is in weight percentage equal to 68%.

Alternatively, the second composite material can be Ultrasuede™.

Exemplarily it is further provided providing a support layer 2 (only schematically shown) comprising a solid thermoplastic foam entirely made of polypropylene cross-linked with physical agents (e.g. heat, ionizing radiations, etc.) and with closed cells. Exemplarily the foam of the support layer 2 is Tracellen™ vertical marketed by Trocellen GmbH.

Exemplarily it is provided providing a semi-finished product 3 comprising the aesthetic layer 1 and the support layer 2 firmly adhered to each other.

Exemplarily (not shown) providing the semi-finished product 3 comprises firmly adhering the aesthetic layer 1 and the support layer 2 to each other by means of a flame adhesion process comprising superficially heating the support layer, to bring at least one face of the support layer to a plastic state, subsequently placing the aesthetic layer on the face in the plastic state and finally cooling the face to solidify it and obtain the adhesion between the two layers.

In one alternative embodiment (not shown), providing the semi-finished product comprises firmly adhering the aesthetic layer and the support layer to each other by means of an adhesive layer, for example a polyolefin or polyurethane or neoprene adhesive.

Exemplarily it is provided heating the semi-finished product 3 to bring the support layer 2 to a plastic state.

Exemplarily, before heating the semi-finished product 3, the aesthetic layer 1 has thickness equal to about 0.8 mm and density per unit of surface equal to about 230 g/m², and the support layer 2 has thickness equal to about 2 mm.

Exemplarily, before heating the semi-finished product 3, the foam has the following properties:
density equal to about 67 kg/m³,
longitudinal tensile strength measured according to ISO 1798 standard equal to about 1.07 MPa,
transversal tensile strength measured according to ISO 1798 standard equal to about 0.63 MPa,
longitudinal strain at break measured according to ISO 1798 standard equal to about 500%,
transversal strain at break measured according to ISO 1798 standard equal to about 378%,
compression stress at 25% strain measured according to ISO 3386/1 standard equal to about 43 kPa,
compression stress at 50% strain measured according to ISO 3386/1 standard equal to about 83 kPa,
dimensional stability measured according to ISO 2796 standard equal to about 130° C.

Exemplarily the process, before heating the semi-finished product 3, comprises fixing the semi-finished product to a support frame 14 (schematically shown in FIGS. 1-3). Exemplarily the support frame keeps the semi-finished product under tension. Optionally (not shown), for example in case of moulding of composite products having surface geometries with wide three-dimensional development (e.g. with pronounced ridges and/or valleys, which require an abundance of material), the semi-finished product can be fixed to the support frame to create a more or less pronounced loop (in order to provide such abundance of material for the moulding).

Exemplarily (FIG. 1) heating the semi-finished product 3 is performed outside the mould and with the semi-finished product fixed to the support frame 14.

Exemplarily heating the semi-finished product comprises providing heat by irradiation directly to the aesthetic layer 1 and to the support layer 2. For this purpose, it is exemplarily provided arranging two heaters 20 (schematically shown in FIG. 1) at opposite sides of the semi-finished product to be able to heat it without contact.

Exemplarily heating the semi-finished product comprises bringing the support layer 2 and the aesthetic layer 1 to respective different temperatures, wherein the support layer is brought to a temperature equal to about 210° C. (to bring the support layer to the plastic state) and the aesthetic layer is brought to a temperature equal to about (to facilitate the forming of the aesthetic layer without damaging it and/or to limit the thermal stress to which the semi-finished product is subjected).

Once the semi-finished product 3 has been heated, it is exemplarily provided, with the semi-finished product fixed to the support frame 14, arranging the semi-finished product between the two half-moulds arranged in an open configuration (FIG. 2).

Exemplarily (FIG. 3) it is subsequently provided forming the semi-finished product 3 by pressing the first 11 and the second half-mould 12 against each other with the semi-finished product interposed between the conformation surfaces 13, and with the support layer 2 in the plastic state.

Exemplarily forming the semi-finished product 3 is performed with the semi-finished product fixed to the support frame 14 (FIG. 3) to facilitate the forming and/or the subsequent removal of the finished product from the mould.

Exemplarily, during the forming phase, the aesthetic layer 1 and the support layer 2 are arranged directly in contact with a respective conformation surface 13.

Subsequently, it is exemplarily provided cooling the semi-finished product 3 to bring the support layer 2 (again) to a solid state and to realize the composite product 9.

Exemplarily cooling the semi-finished product is performed by means of both the first 11 and the second half-mould 12 kept (e.g. by thermal inertia or by means of a cooling system) at a lower temperature than the temperature of the aesthetic layer 1 as a consequence of the heating of the semi-finished product 3 (e.g. the temperature of the half-moulds is about 20-25° C.).

Finally, it is exemplarily provided opening the mould and removing the composite product 9 (e.g. by means of the support frame 14 to which the composite product is still fixed). Optionally (not shown) the composite product (before and/or after being removed from the mould) can be subjected to finishing operations, for example smoothing and/or cutting of any protruding portions of the aesthetic layer and/or of the support layer, to adapt it to the manufacturing standards.

With reference to FIG. 4, the composite product 9 comprises the aesthetic layer 1 and the support layer 2 in the solid state after the aforementioned cooling. Exemplarily the composite product 9 comprises the support layer 2 in the solid state as sole layer having self-supporting function.

1. Process for moulding a composite product for coatings, the process comprising:
providing an aesthetic layer comprising an aesthetic material selected from the following group of materials: natural leather, a first composite material comprising a textile layer and a covering layer comprising polyurethane or polyvinyl chloride or thermoplastic olefins and a second composite material comprising a non-woven fabric comprising polyester or polyamide fibres immersed in a polyurethane matrix, wherein said polyurethane is in weight percentage greater than or equal to 15% and less than or equal to 60% and said polyester or said polyamide is in weight percentage greater than or equal to 40% and less than or equal to 85%;
providing a support layer comprising a polyolefin thermoplastic solid foam;
providing a semi-finished product comprising said aesthetic layer and said support layer coupled together;
providing a mould comprising a first and a second half-mould each having a respective conformation surface;
heating said semi-finished product to bring said support layer to a plastic state;
forming said semi-finished product by pressing said first and second half-mould against each other with said semi-finished product (3) interposed between said conformation surfaces, and with said support layer in said plastic state;
subsequently to said forming, cooling said semi-finished product to bring said support layer to a solid state and to realize said composite product.

2. Process according to claim 1, wherein the first and the second composite material are artificial leather, wherein said aesthetic layer is in single piece and it is entirely made of said aesthetic material, wherein said composite product comprises said support layer in the solid state as sole layer having self-supporting function, and wherein in said second composite material a sum of the weight percentages of said polyurethane and of said polyester or said polyamide is greater than or equal to 95%, preferably it is equal to 100%, of a whole mass of said second composite material.

3. Process according to claim 1, wherein said textile layer of the first composite material is woven fabric or knitted fabric or non-woven fabric, wherein said textile layer of the first composite material is made of synthetic textile fibres or of natural textile fibres, wherein said fibres of said second composite material are entirely of polyester, preferably they are coagulated polyester fibres, wherein said fibres of said second composite material have diameter less than or equal to 50 μm, and wherein said foam is made of polypropylene or polyethylene.

4. Process according to claim 1, wherein said first composite material is Feel Tek™, wherein said second composite material is selected from the following: Alcantara™, Ultrasuede™, and wherein said foam is Trocellen™ vertical.

5. Process according to claim 1, wherein said aesthetic layer, before said heating said semi-finished product, has thickness greater than or equal to 0.5 mm and less than or equal to 1.3 mm, and density per unit surface greater than or equal to 180 g/m2 and less than or equal to 280 g/m2, wherein before said forming said semi-finished product, a thickness of said support layer is greater than or equal to 1.5 mm and less than or equal to 2.5 mm.

6. Process according to claim 1, wherein said foam is crosslinked with physical agents and it has closed cells, and wherein said foam, before said heating said semi-finished product, has:
density greater than or equal to 40 kg/m3, and less than or equal to 90 kg/m3;
longitudinal tensile strength measured according to ISO 1798 standard greater than or equal to 0.5 MPa, and less than or equal to 2 MPa;
transversal tensile strength measured according to ISO 1798 standard greater than or equal to 0.3 MPa, and less than or equal to 1 MPa;
longitudinal strain at break measured according to ISO 1798 standard greater than or equal to 400%, and less than or equal to 600%;
transversal strain at break measured according to ISO 1798 standard greater than or equal to 300%, and less than or equal to 450%;
compression stress at 25% strain measured according to ISO 3386/1 standard greater than or equal to 30 kPa, and less than or equal to 50 kPa;
compression stress at 50% strain measured according to ISO 3386/1 standard greater than or equal to 70 kPa, and less than or equal to 90 kPa;
dimensional stability measured according to ISO 2796 standard greater than or equal to 120° C., and less than or equal to 140° C.

7. Process according to claim 1, wherein said semi-finished product, before said forming said semi-finished product, has substantially planar shape, wherein it is provided arranging said semi-finished product with said aesthetic layer and said support layer firmly adhered to each other, wherein said providing said semi-finished product comprises firmly adhering said aesthetic layer and said support layer to each other by means of a flame adhesion process comprising:
superficially heating said support layer, to bring at least one face of said support layer to a plastic state,
subsequently, placing said aesthetic layer on said face in said plastic state,
cooling said face to solidify said face and to obtain adhesion;
or wherein said providing said semi-finished product comprises firmly adhering said aesthetic layer and said support layer to each other by means of an adhesive layer.

8. Process according to claim 1, wherein said heating said semi-finished product is performed outside said mould (10), wherein said process, before said heating said semi-finished product, comprises fixing said semi-finished product to a support frame, wherein said heating said semi-finished product is performed with said semi-finished product fixed to said support frame, wherein said heating said semi-finished product comprises bringing said support layer and said aesthetic layer to respective mutually different temperatures, wherein said heating said semi-finished product comprises providing heat directly to said support layer, preferably by irradiation, and it comprises bringing said support layer to a temperature greater than or equal to 180° C., and less than or equal to 240° C., and wherein said heating said semi-finished product comprises providing heat directly also to said aesthetic layer, preferably by irradiation, to bring said aesthetic layer to a temperature greater than or equal to and less than or equal to 110° C.

9. Process according to claim 8, wherein said forming said semi-finished product is performed with said semi-finished product fixed to said support frame, and wherein, during said forming, each of said aesthetic layer and support layer is arranged directly in contact with a respective conformation surface.

10. Process according to claim 1, wherein said cooling said semi-finished product is performed by means of at least one of said first and second half-mould placed at temperature lower than a temperature of said aesthetic layer as a consequence of said heating said semi-finished product.
